(19) United States
(12) Patent Application Publication
(10) Pub. No.: US 2026/0202926 A1
(43) Pub. Date: Jul. 16, 2026

(54) ELECTRONIC DEVICE

(71) Applicant: CARUX TECHNOLOGY PTE. LTD., SINGAPORE (SG)

(72) Inventors: Chia-Hung Hsieh, Tainan (TW); Hsien-Chang Chen, Tainan (TW); Ming-Cheng Hsieh, Tainan (TW); Yao-Lin Huang, Tainan (TW)

(73) Assignee: CARUX TECHNOLOGY PTE. LTD., SINGAPORE (SG)

(21) Appl. No.: 19/425,984

(22) Filed: Dec. 18, 2025

(30) Foreign Application Priority Data
Jan. 13, 2025 (CN) 202510050254.2

(51) Int. Cl. G06F 3/041; G06F 3/01

(52) U.S. Cl. CPC G06F 3/04142; G06F 3/016

(57) ABSTRACT

An electronic device is provided. The electronic device includes a base, a display unit, a force sensing unit, and an elastic element. The display unit is disposed on the base. The force sensing unit includes a first fixing element, a second fixing element, a connecting rod, and a sensing circuit. The first fixing element is connected to the base. The second fixing element is connected to the display unit. The connecting rod is partially disposed between the first fixing element and the second fixing element. The sensing circuit is disposed on the connecting rod. The elastic element surrounds at least one of the first fixing element and the second fixing element.

### CROSS-REFERENCE TO RELATED APPLICATION

This application claims the priority benefit of China application serial no. 202510050254.2, filed on January 13, 2025. The entirety of the above-mentioned patent application is hereby incorporated by reference herein and made a part of this specification.

### BACKGROUND

The touch sensation of a touchscreen may be blocked by vibrations caused by a vehicle traveling along the road surface. The energy generated by these vibrations is transmitted from the chassis of the vehicle along the vehicle frame to the automotive display device. A driver operating the display device may be unable to perceive tactile feedback due to the blocking of vibrations caused by the vehicle body, making it difficult for the driver to make judgments. As a result, the driver is likely to rely on visually checking the screen, causing the driver’s attention to be diverted from the road and leading to distraction.

### BRIEF DESCRIPTION OF THE DRAWINGS

FIG. 1A is a top view schematic diagram of an electronic device according to an embodiment of the disclosure.

FIG. 1B is a cross-sectional schematic diagram along line I-I of FIG. 1A.

FIG. 2 to FIG. 3 are schematic cross-sectional views of various electronic devices according to a plurality of embodiments of the disclosure.

FIG. 4 to FIG. 8 are schematic partial cross-sectional views of various electronic devices according to a plurality of embodiments of the disclosure.

FIG. 9 is a three-dimensional partial perspective schematic diagram of an elastic element according to an embodiment of the disclosure.

### DESCRIPTION OF THE EMBODIMENTS

The disclosure may be understood by referring to the following detailed description in conjunction with the accompanying drawings. It should be noted that, to facilitate understanding and for simplicity of the illustrations, specific components in the drawings are not drawn to actual scale, and the quantities and dimensions of the components shown in the figures are merely illustrative and are not intended to limit the scope of the disclosure.

In some embodiments of the disclosure, terms related to engagement and connection, such as “connected” or “interconnected”, unless specifically defined otherwise, may refer to two structures being in direct contact, or alternatively, to two structures not being in direct (indirect) contact, with other structures disposed between the two structures. Moreover, the terms related to engagement and connection may also include situations where both structures are movable or both structures are fixed.

In the disclosure, an optical microscope (OM), scanning electron microscope (SEM), thin film thickness profiler (α-step), ellipsometer, or other suitable methods may be used to measure the area, width, thickness, or height of components, or the distance or spacing between components.

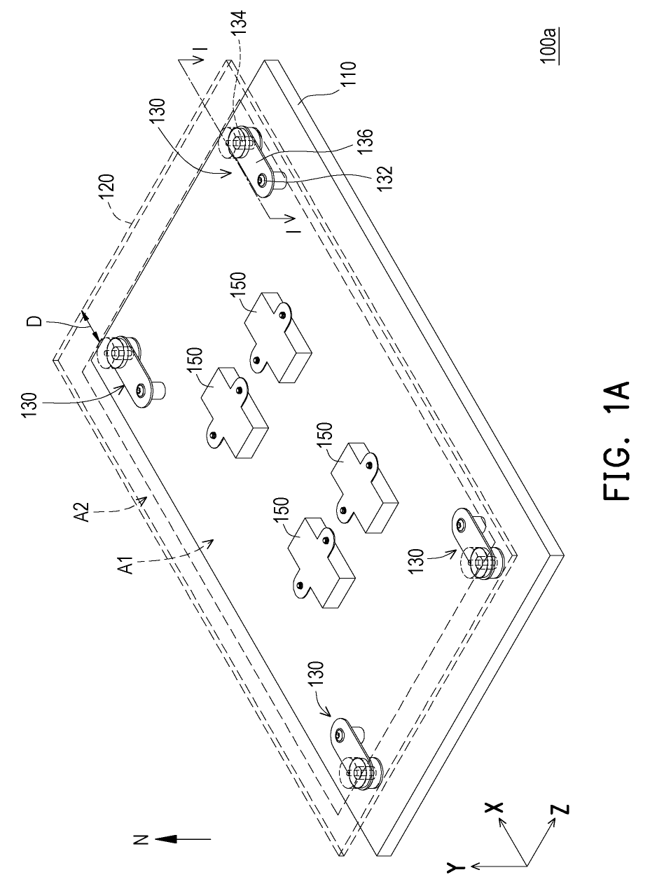

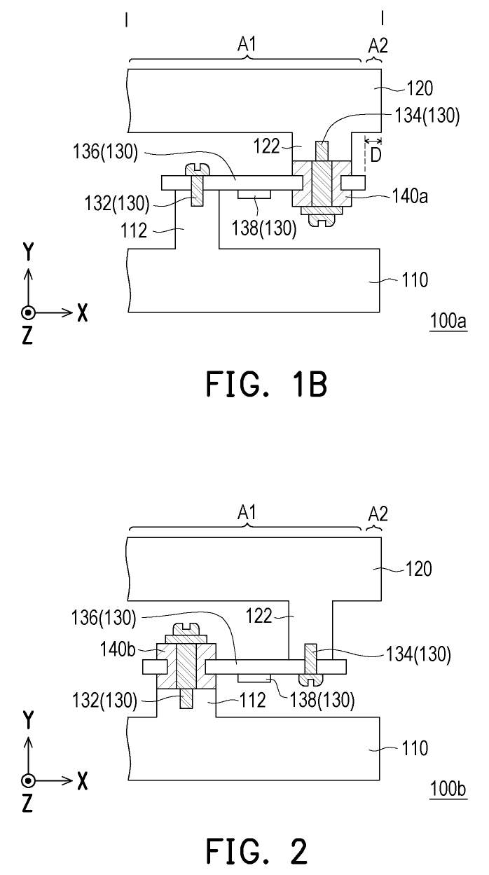

FIG. 1A is a top-view schematic diagram of an electronic device according to an embodiment of the disclosure. FIG. 1B is a cross-sectional schematic diagram along line I-I of FIG. 1A. For convenience and clarity, components such as the display unit in FIG. 1A are represented with dashed lines. Referring to both FIG. 1A and FIG. 1B, in this embodiment, an electronic device 100a includes a base 110, a display unit 120, a force sensing unit 130, and an elastic element 140a. The display unit 120 is disposed on the base 110. The force sensing unit 130 includes a first fixing element 132, a second fixing element 134, a connecting rod 136, and a sensing circuit 138. The first fixing element 132 is connected to the base 110. The second fixing element 134 is connected to the display unit 120. The connecting rod 136 is partially disposed between the first fixing element 132 and the second fixing element 134. The sensing circuit 138 is disposed on the connecting rod 136. The elastic element 140a surrounds at least one of the first fixing element 132 and the second fixing element 134.

In an embodiment, the base 110 may, for example, be a vehicle frame, and the display unit 120 may be a touchscreen display for vehicles. In an embodiment, the display unit 120 is a non-self-emissive display, such as a liquid crystal display (LCD), but is not limited thereto. In another embodiment, the display unit 120 may be a self-emissive display, such as an organic light-emitting diode (OLED) display, a micro light-emitting diode (Micro-LED) display, a mini light-emitting diode (Mini-LED) display, or a quantum dot light-emitting diode (quantum dot LED) display, but is not limited thereto. In an embodiment, the base 110 and the display unit 120 are arranged correspondingly in an up-and-down configuration, wherein a first support pillar 112 of the base 110 and a second support pillar 122 of the display unit 120 are arranged in a staggered manner. The display unit 120 includes a display region A1 and a peripheral region A2 surrounding the display region A1. The force sensing unit 130 is located in the display region A1, and in a normal direction N perpendicular to the display unit A1, a distance D between the force sensing unit 130 and the peripheral region A2 is greater than or equal to 0 and less than or equal to 50 millimeters.

Furthermore, the force sensing unit 130 is used to measure the force applied by a user to the display unit 120. In some embodiments, the force sensing unit 130 is used to measure the force applied by a user in the normal direction N of the display unit 120. In an embodiment, the number of force sensing units 130 located in the display region A1 is at least four, with each force sensing unit positioned at a corner of the display region A1. The first fixing element 132 of the force sensing unit 130 is connected to and fixed on the first support pillar 112 of the base 110, while the second fixing element 134 of the force sensing unit 130 is connected to and fixed on the second support pillar 122 of the display unit 120. In an embodiment, the first fixing element 132 and the second fixing element 134 may be, for example, screws or bolts. The connecting rod 136 of the force sensing unit 130 is connected to the first fixing element 132 and the second fixing element 134. The sensing circuit 138 of the force sensing unit 130 is located on the surface of the connecting rod 136 facing the base 110 and may be used to detect pressing forces. In an embodiment, the sensing circuit 138 is, for example, a strain gauge. In an embodiment, each connecting rod 136 may have one or more sensing circuits 138 disposed thereon.

In this embodiment, the elastic element 140a is located on the display unit 120, wherein the elastic element 140a surrounds the second fixing element 134, and the connecting rod 136 surrounds the elastic element 140a. Here, “one component surrounds another component” may mean that the component is at least partially in contact with the side surface of the other component in the cross-sectional view of the electronic device 100a. In an embodiment, the elastic element 140a is a solid elastic element. In an embodiment, the number of the elastic elements 140a is equal to or greater than the number of the force sensing units 130. In an embodiment, the material of the elastic element 140a is, for example, a single material or a combination of multiple materials, that is, a composite material. The purpose of the elastic element 140a is to buffer the downward force applied to the display unit 120, increase the reliability of the connecting rod 136, reduce noise, and allow the sensing circuit 138 to filter out pressing signals. In an embodiment, the elastic element 140a may be considered as a vibration isolator.

Additionally, the electronic device 100a of this embodiment further includes a vibration actuator 150, which is disposed on the surface of the display unit 120 facing the base 110. In an embodiment, the number of vibration actuators 150 is, for example, four, located within the display region A1, while the force sensing unit 130 is positioned around the vibration actuators 150.

In an embodiment, when a user presses the display region A1 of the display unit 120, the pressing force is transmitted through the elastic element 140a to the connecting rod 136 of the force sensing unit 130 and then further transmitted by the connecting rod 136 to the sensing circuit 138. At this time, the pressing force is neither absorbed nor suppressed, and the pressing force reaches the target value. Subsequently, the vibration actuator 150 is activated, causing the vibration energy to drive the display unit 120 to displace in the Y-Z plane direction, allowing the vibration energy to be transmitted to the position of the display unit 120 touched by the user. In other words, the elastic element 140a provides displacement space for lateral movement, enabling the display unit 120 to be moved by the vibration actuator 150. Thereafter, the user perceives tactile feedback, completing the pressing action.

In short, the purpose of the elastic element 140a is primarily to block external vibrations transmitted through the base 110 that interfere with the entire tactile feedback device (i.e., the display unit 120). In an embodiment, the number of force sensing units 130 and their corresponding elastic elements 140a is at least four, forming a large surface that provides sufficient support area to bear downward stress and effectively detect pressing forces within the display region A1 of the display unit 120. Furthermore, the electronic device 100a of this embodiment is a two-layer structure formed by the base 110 and the display unit 120, achieving the objectives of reduced thickness and lightweight design.

FIG. 2 is a cross-sectional schematic diagram of an electronic device according to an embodiment of the disclosure. Referring to both FIG. 1B and FIG. 2, an electronic device 100b of this embodiment is similar to the electronic device 100a in FIG. 1B. The difference between the two is that, in this embodiment, an elastic element 140b is located on the base 110, wherein the elastic element 140b surrounds the first fixing element 132, and the connecting rod 136 surrounds the elastic element 140b.

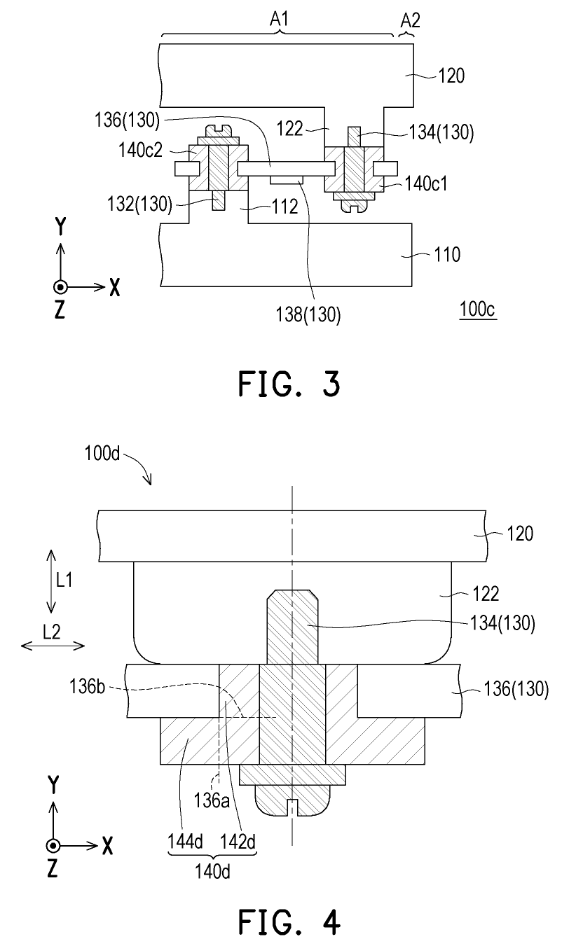

FIG. 3 is a cross-sectional schematic diagram of an electronic device according to another embodiment of the disclosure. Referring to both FIG. 1B and FIG. 3, an electronic device 100c of this embodiment is similar to the electronic device 100a in FIG. 1B. The difference between the two is that, in this embodiment, an elastic element 140c1 is located on the display unit 120 and surrounds the second fixing element 134, while an elastic element 140c2 is located on the base 110 and surrounds the first fixing element 132. Additionally, the connecting rod 136 surrounds both the elastic element 140c1 and the elastic element 140c2.

FIG. 4 is a partial cross-sectional schematic diagram of an electronic device according to an embodiment of the disclosure. Referring to both FIG. 1B and FIG. 4, an electronic device 100d of this embodiment is similar to the electronic device 100a in FIG. 1B. The difference between the two is that, in this embodiment, an elastic element 140d includes a first portion 142d and a second portion 144d. A first extension direction L1 of the first portion 142d is different from a second extension direction L2 of the second portion 144d. In some embodiments, the edge extension line of the connecting rod 136 may serve as the boundary line between the first portion 142d and the second portion 144d. For example, the boundary line between the first portion 142d and the second portion 144d may be an edge extension line 136a along the first extension direction L1, and the boundary line between the first portion 142d and the second portion 144d may be an edge extension line 136b along the second extension direction L2, but this is not limiting. In an embodiment, the first extension direction L1 is perpendicular to the second extension direction L2. In some embodiments, the first extension direction L1 is parallel to the normal direction of the display unit 120, and the second extension direction L2 is perpendicular to the normal direction of the display unit 120, but this is not limiting. In an embodiment, the material of the first portion 142d is the same as the material of the second portion 144d. In an embodiment, the first portion 142d and the second portion 144d are integrally formed. In an embodiment, the material of the first portion 142d may include two materials, while the material of the second portion 144d may be the same as one of the two materials of the first portion 142d or the material of the second portion 144d is different from the material of the first portion 142d. In other words, the material of the elastic element 140d may be a single material or composed of two or more different materials. When the elastic element 140d is made of multiple different materials, the elastic element 140d may be formed as a composite elastic element 140d through assembly, stacking, or material molding methods.

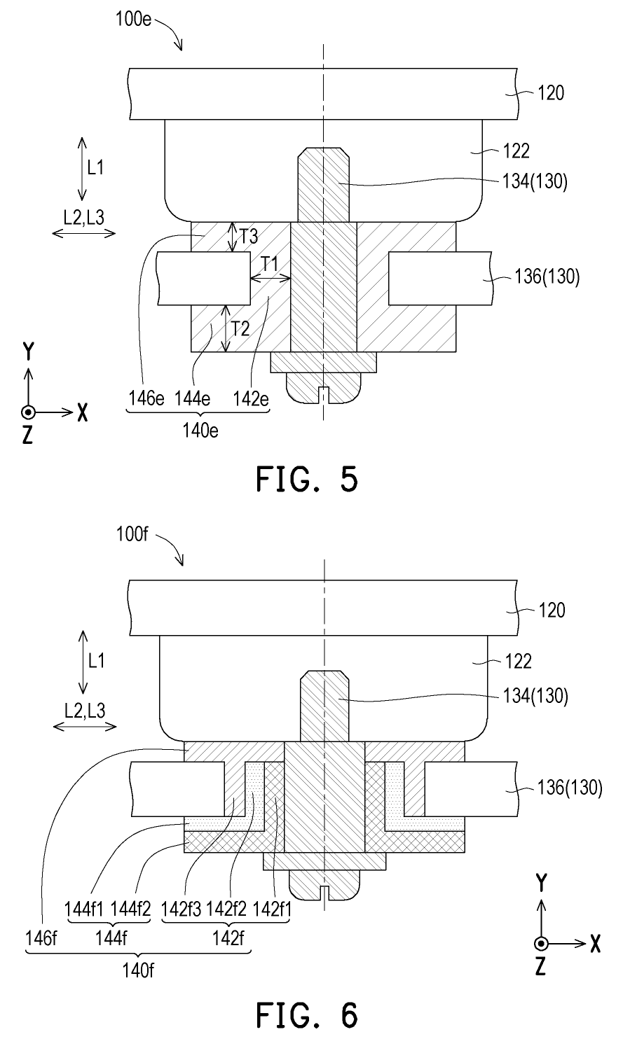

FIG. 5 is a partial cross-sectional schematic diagram of an electronic device according to another embodiment of the disclosure. Referring to both FIG. 4 and FIG. 5, an electronic device 100e of this embodiment is similar to the electronic device 100d in FIG. 4. The difference between the two is that, in this embodiment, an elastic element 140e further includes a third portion 146e, wherein a third extension direction L3 of the third portion 146e is the same as the second extension direction L2 of a second portion 144e, and a first portion 142e is connected to the second portion 144e and the third portion 146e. In some embodiments, the edge extension line of the connecting rod 136 may serve as the boundary line between the first portion 142e, the second portion 144e, and the third portion 146e. In an embodiment, a first thickness T1 of the first portion 142e is less than or equal to a second thickness T2 of the second portion 144e, while a third thickness T3 of the third portion 146e is greater than or equal to 0 and less than the first thickness T1 of the first portion 142e. In an embodiment, the elastic modulus of the first portion 142e is the same as the elastic modulus of the second portion 144e and greater than the elastic modulus of the third portion 146e, which may provide displacement space needed for vibration and swinging through compression and rebound in the planar direction. In some embodiments, the first thickness T1 is measured as the length of the first portion perpendicular to the first extension direction L1, the second thickness T2 is measured as the length of the second portion perpendicular to the second extension direction L2, and the third thickness T3 is measured as the length of the third portion perpendicular to the third extension direction L3, but this is not limiting. In some embodiments, the elastic modulus may refer to the spring constant, with units of Newtons per meter (N/m). The elastic modulus may also refer to Young’s modulus, with units of Newtons per square meter (N/m2). The elastic modulus may, for example, be measured using a universal testing machine, but the method of obtaining the elastic modulus is not limited thereto.

In an embodiment, the material of the first portion 142e, the material of the second portion 144e, and the material of the third portion 146e are the same. In an embodiment, the first portion 142e, the second portion 144e, and the third portion 146e are integrally formed. In an embodiment, the material of the first portion 142e may include two materials, while the material of the second portion 144e is the same as one of the two materials of the first portion 142e, and the material of the third portion 146e is the same as the material of the first portion 142e. In an embodiment, the material of the first portion 142e may include two materials, while the material of the second portion 144e is different from the material of the first portion 142e, and the material of the third portion 146e is the same as one of the two materials of the first portion 142e.

In an embodiment, the pressing force applied by the user is transmitted through the third portion 146e of the elastic element 140e to the connecting rod 136 via the display unit 120 and then further transmitted by the connecting rod 136 to the sensing circuit 138 located on the connecting rod 136 (Referring to FIG. 1B). At this time, the pressing force is neither isolated nor suppressed. Simultaneously, the compression and rebound deformation of the first portion 142e of the elastic element 140e allow the vibration energy of the vibration actuator 150 (Referring to FIG. 1A) to be transmitted to the area of the display unit 120 touched by the user. The deformation of the second portion 144e and the third portion 146e of the elastic element 140e blocks the transmission of vibration energy to the base 110 (Referring to FIG. 1A and FIG. 1B).

FIG. 6 is a partial cross-sectional schematic diagram of an electronic device according to another embodiment of the disclosure. Referring to both FIG. 5 and FIG. 6, an electronic device 100f of this embodiment is similar to the electronic device 100e in FIG. 5. The difference between the two is that, in this embodiment, a first portion 142f of an elastic element 140f includes a first material part 142f1, a second material part 142f2, and a third material part 142f3. The second material part 142f2 is located between the first material part 142f1 and the third material part 142f3. The first material part 142f1 is located between the second fixing element 134 and the second material part 142f2, while the third material part 142f3 is located between the second material part 142f2 and the connecting rod 136. The material of the first material part 142f1 is different from the material of the second material part 142f2, and the material of the second material part 142f2 is different from the material of the third material part 142f3. Additionally, a second portion 144f of the elastic element 140f includes a first material part 144f1 and a second material part 142f2. The first material part 144f1 is located between the connecting rod 136 and the second material part 144f2. The material of the first material part 144f1 is the same as the material of the second material part 142f2 of the first portion 142f, while the material of the second material part 144f2 is the same as the material of the first material part 142f1 of the first portion 142f. The material of a third portion 146f of the elastic element 140f is the same as the material of the third material part 142f3 of the first portion 142f. In an embodiment, the third portion 146f and the third material part 142f3 of the first portion 142f are integrally formed. In an embodiment, the first material part 144f1 of the second portion 144f and the second material part 142f2 of the first portion 142f are integrally formed. In an embodiment, the second material part 144f2 of the second portion 144f and the first material part 142f1 of the first portion 142f are integrally formed.

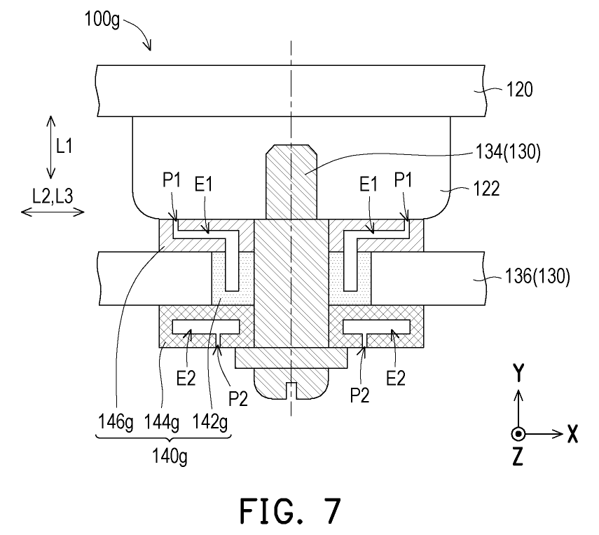

FIG. 7 is a partial cross-sectional schematic diagram of an electronic device according to another embodiment of the disclosure. Referring to both FIG. 5 and FIG. 7, an electronic device 100g of this embodiment is similar to the electronic device 100e in FIG. 5. The difference between the two is that, in this embodiment, an elastic element 140g includes at least one hollow part (multiple hollow parts including the hollow part E1 and the hollow part E2 are schematically shown). The hollow part E1 is located within a first portion 142g and the third portion 143g of the elastic element 140g, and is connected to an exhaust port P1 located within a third portion 146g and extending to the outside. The hollow part E2 is located within a second portion 144g of the elastic element 140g, and is connected to an exhaust port P2 located within the second portion 144g and extending to the outside. The material of the first portion 142g of the elastic element 140g is different from the material of the second portion 144g, and the material of the second portion 144g is different from the material of the third portion 146g. Through the configuration of the hollow parts, different portions of the elastic element may exhibit different elastic moduli. In some embodiments, the greater the number of hollow parts, the smaller the exhibited elastic modulus.

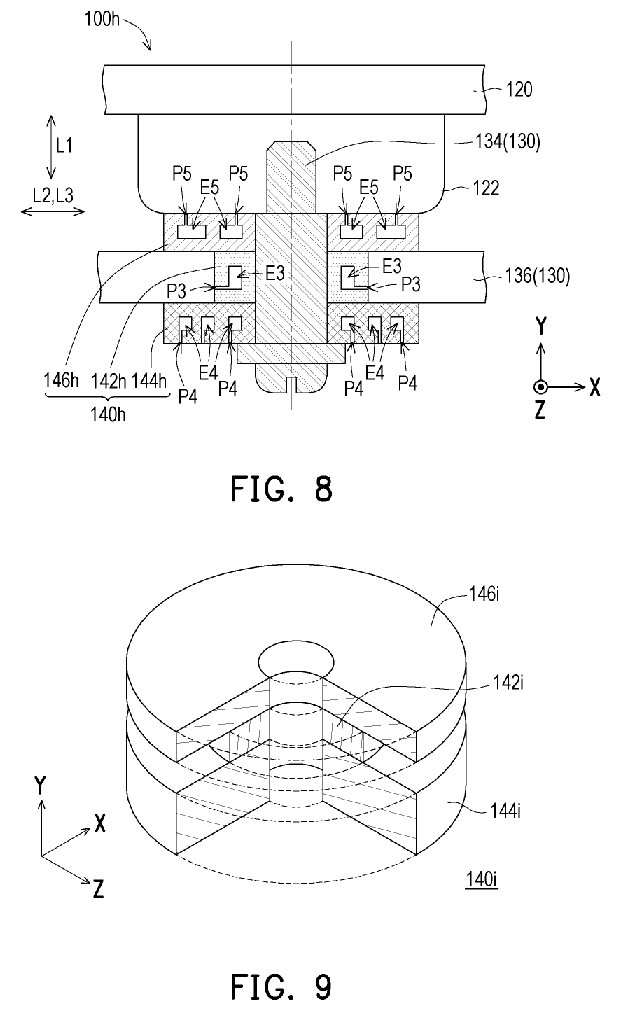

FIG. 8 is a partial cross-sectional schematic diagram of an electronic device according to another embodiment of the disclosure. Referring to both FIG. 5 and FIG. 8, an electronic device 100h of this embodiment is similar to the electronic device 100e in FIG. 5. The difference between the two is that, in this embodiment, an elastic element 140h includes at least one hollow part (multiple hollow parts including the hollow part E3, the hollow part E4, and the hollow part E5 are schematically shown). The hollow part E3 is located within a first portion 142h of the elastic element 140h and is connected to an exhaust port P3 located within the first portion 142h and extending to the outside. The hollow part E4 is located within a second portion 144h of the elastic element 140h and is connected to an exhaust port P4 located within the second portion 144h and extending to the outside. The hollow part E5 is located within a third portion 146h of the elastic element 140h and is connected to an exhaust port P5 located within the third portion 146h and extending to the outside. The material of the first portion 142h of the elastic element 140h is different from the material of the second portion 144h, and the material of the second portion 144h is different from the material of the third portion 146h, but this is not limiting.

FIG. 9 is a three-dimensional partial perspective schematic diagram of an elastic element according to an embodiment of the disclosure. Referring to FIG. 9. In this embodiment, the shapes of a first portion 142i, a second portion 144i, and a third portion 146i of an elastic element 140i are each hollow and annular. In an embodiment, the diameter of the first portion 142i is smaller than the diameter of the second portion 144i and the diameter of the third portion 146i, while the diameter of the second portion 144i is equal to the diameter of the third portion 146i. In an embodiment, the cross-sectional shapes of the first portion 142i, the second portion 144i, and the third portion 146i may each include polygons (e.g., rectangles, pentagons, hexagons, octagons), circles, ellipses, polygons with chamfers (e.g., rectangles with one side having a chamfered C-shape, rectangles with one side having a chamfered R-shape, rectangles with rounded R-corners), or combinations of the above shapes (e.g., rectangles combined with semicircles).

In the embodiments of the disclosure, the first fixing element and the second fixing element of the force sensing unit are respectively connected to the base and the display unit. The first fixing element and the second fixing element are connected through the connecting rod, and the sensing circuit is disposed on the connecting rod. Additionally, the elastic element surrounds at least one of the first fixing element and the second fixing element. Through this design, vibrations transmitted from the base may be effectively isolated, allowing the electronic device of the disclosure to achieve better vibration isolation effects.

Finally, it should be noted that the above embodiments are used to illustrate the technical solutions of the disclosure and are not intended to limit them. Although the disclosure has been described in detail with reference to the above embodiments, those of ordinary skill in the art should understand that modifications may still be made to the technical solutions described in the foregoing embodiments, or some or all of the technical features may be replaced with equivalents. These modifications or replacements do not cause the essence of the corresponding technical solutions to depart from the scope of the technical solutions of the embodiments of the disclosure.

What is claimed is:

1. An electronic device, comprising:
a base;
a display unit, disposed on the base;
a force sensing unit, comprising:
a first fixing element, connected to the base;
a second fixing element, connected to the display unit;
a connecting rod, partially disposed between the first fixing element and the second fixing element; and
a sensing circuit, disposed on the connecting rod; and
an elastic element, surrounding at least one of the first fixing element and the second fixing element.

2. The electronic device according to claim 1, wherein the display unit has a display region and a peripheral region surrounding the display region, the force sensing unit is located in the display region, and in a direction perpendicular to a normal direction of the display unit, a distance between the force sensing unit and the peripheral region is greater than or equal to 0 and is less than or equal to 50 millimeters.

3. The electronic device according to claim 1, wherein the connecting rod surrounds the elastic element.

4. The electronic device according to claim 1, wherein the elastic element comprises a first portion and a second portion, and a first extension direction of the first portion is different from a second extension direction of the second portion.

5. The electronic device according to claim 4, wherein the elastic element further comprises a third portion, a third extension direction of the third portion is the same as the second extension direction of the second portion, and the first portion is connected to the second portion and the third portion.

6. The electronic device according to claim 5, wherein an elastic modulus of the first portion is the same as an elastic modulus of the second portion and is greater than an elastic modulus of the third portion.

7. The electronic device according to claim 5, wherein a first thickness of the first portion is less than or equal to a second thickness of the second portion, and a third thickness of the third portion is greater than or equal to 0 and less than the first thickness of the first portion.

8. The electronic device according to claim 4, wherein a cross-sectional shape of the first portion comprises a polygon, a circle, an ellipse, a polygon with a chamfer, or a combination thereof.

9. The electronic device according to claim 4, wherein the first extension direction is parallel to a normal direction of the display unit, and the second extension direction is perpendicular to the normal direction of the display unit.

10. The electronic device according to claim 4, wherein a material of the first portion is the same as a material of the second portion.

11. The electronic device according to claim 4, wherein the first portion comprises two materials, and a material of the second portion is the same as one of the two materials of the first portion.

12. The electronic device according to claim 4, wherein the first portion of the elastic element comprises a first material part, a second material part, and a third material part, wherein the second material part is located between the first material part and the third material part, the first material part is located between the second fixing element and the second material part, and the third material part is located between the second material part and the connecting rod.

13. The electronic device according to claim 4, wherein the second portion of the elastic element comprises a first material part and a second material part, and the first material part is located between the connecting rod and the second material part.

14. The electronic device according to claim 1, wherein the elastic element is a solid elastic element.

15. The electronic device according to claim 1, wherein the elastic element comprises at least one hollow part.

16. The electronic device according to claim 1, wherein a first support pillar of the base and a second support pillar of the display unit are arranged in a staggered manner.

17. The electronic device according to claim 16, wherein the first fixing element of the force sensing unit is connected to and fixed on the first support pillar of the base, and the second fixing element of the force sensing unit is connected to and fixed on the second support pillar of the display unit.

18. The electronic device according to claim 1, wherein a quantity of the elastic element is greater than or equal to a quantity of the force sensing unit.

19. The electronic device according to claim 1, further comprising:
a vibration actuator, disposed on a surface of the display unit facing the base.

20. The electronic device according to claim 19, wherein the force sensing unit is located around the vibration actuator.
